(19) United States
(12) Patent Application Publication
(10) Pub. No.: US 2026/0211866 A1
(43) Pub. Date: Jul. 23, 2026

(54) Systems and Methods for Autonomous AI Agent Configuration and Execution in a Database System

(71) Applicant: Salesforce, Inc., San Francisco, CA (US)

(72) Inventor: Prithvi Krishnan PADMANABHAN, San Ramon, CA (US)

(21) Appl. No.: 19/238,904

(22) Filed: Jun. 16, 2025

Related U.S. Application Data
(60) Provisional application No. 63/746,872, filed on Jan. 17, 2025.

(51) Int. Cl. G06F 16/23; G06N 3/0475

(52) U.S. Cl. CPC G06F 16/235; G06N 3/0475

(57) ABSTRACT

A computing services environment may include application servers providing computing services to a plurality of entities, a unified metadata framework including autonomous agent definitions referencing action definitions defining actions capable of being performed within the computing services environment, an agent studio configured to create a personal autonomous agent definition specific to a user account, an agent service configured to instantiate an autonomous agent instance based on a corresponding autonomous agent definition of the plurality of autonomous agent definitions, and an orchestration layer configured to determine an orchestration plan based on novel planning text generated by a generative language model. The orchestration plan may include a subset of the plurality of actions identified in the novel planning text. The computing services environment may be configured to execute the subset of the plurality of actions.

### CROSS-REFERENCE TO RELATED APPLICATIONS

This application claims the benefit under 35 U.S.C. § 119(e) of U.S. Provisional Patent Application 63/746,872 (Attorney Docket No. SFDCP255P) by Padmanabhan, titled: “Personal Autonomous AI Agents in a Database System”, filed on Jan. 17, 2025, which is incorporated herein by reference in its entirety for all purposes.

### FIELD OF TECHNOLOGY

This patent application relates generally to database systems, and more specifically to autonomous artificial intelligence agents implemented in the context of database systems.

### BACKGROUND

Autonomous artificial intelligence agents take advantage of recent advances in large language models to generate novel text, interact with people, and perform various types of operations with minimal or no oversight. Autonomous artificial intelligence agents typically rely on one or more standard large language models. Such models are typically not tuned for a particular purpose, but rather are used in a variety of applications. Like humans, however, large language models are capable of a wide range of behaviors, whereas a provider of an autonomous artificial intelligence agent would generally prefer that the agent behave in particular ways.

Creating an autonomous artificial intelligence agent using conventional techniques involves manually crafting prompts and natural language instructions. Even after such a manual process, the autonomous artificial intelligence agent will be imperfectly adapted to its intended purpose. For instance, different people may configure an autonomous artificial intelligence agent in very different ways, leading to different performance in different situations. Accordingly, improved techniques for the configuration of autonomous artificial intelligence agents are desired.

### BRIEF DESCRIPTION OF THE DRAWINGS

The included drawings are for illustrative purposes and serve only to provide examples of possible structures and operations for the disclosed inventive systems, apparatus, methods, and computer program products for generative creation of artificial intelligence agents in a database system. These drawings in no way limit any changes in form and detail that may be made by one skilled in the art without departing from the spirit and scope of the disclosed implementations.

FIG. 1 illustrates an autonomous artificial intelligence agent creation overview method, performed in accordance with one or more embodiments.

FIG. 2 illustrates various elements that may be included within a computing services environment, configured in accordance with one or more embodiments.

FIG. 3 illustrates a method for creating a personal autonomous agent, performed in accordance with one or more embodiments.

FIG. 4 illustrates a method for editing a personal autonomous agent, performed in accordance with one or more embodiments.

FIG. 5 illustrates a method of instantiating and executing a personal autonomous agent, performed in accordance with one or more embodiments.

FIG. 6 illustrates a computing services environment, configured in accordance with one or more embodiments.

FIG. 7 illustrates a method providing an overview of the lifecycle of an autonomous agent, performed in accordance with one or more embodiments.

FIG. 8 illustrates a trust model for the autonomous agent platform, configured in accordance with one or more embodiments.

FIG. 9 illustrates an architecture diagram of elements of the computing services environment, configured in accordance with one or more embodiments.

FIG. 10 shows a block diagram of an example of an environment that includes an on-demand database service configured in accordance with some implementations.

FIG. 11A shows a system diagram of an example of architectural components of an on-demand database service environment, configured in accordance with some implementations.

FIG. 11B shows a system diagram further illustrating an example of architectural components of an on-demand database service environment, in accordance with some implementations.

FIG. 12 illustrates one example of a computing device, configured in accordance with one or more embodiments.

FIG. 13, FIG. 14, and FIG. 15 illustrate user interfaces generated in accordance with one or more embodiments.

### DETAILED DESCRIPTION

### Introduction

Techniques and mechanisms described herein provide for the creation of a personal autonomous agent within a computing services environment. The personal autonomous agent may be created in a manner that is specific to a user account within the computing services environment. The personal autonomous agent may be configured based on configuration information specific to the user account. Alternatively, or additionally, the personal autonomous agent may be instantiated within a context associated with the user account. For instance, the personal autonomous agent may be configured to perform operations within the role of the user account, such as accessing and/or updating information in accordance with authorization associated with the user account.

Various embodiments described herein relate generally to artificial intelligence techniques. Generative AI models can be applied in a computing services environment in any of various ways. One way in which generative AI models may be applied involves integrating such models into existing applications. Such models are typically task-specific offering enhancements to core functionalities. For instance, generative AI models may be used to generate emails, service replies, work summaries, and the like. Such models are often tightly integrated into existing, task-specific applications. They often have limited autonomous and interactions driven by user interfaces. Although various details regarding autonomous agents are discussed in this application, additional details are discussed in U.S. patent application Ser. No. 19/037,321 by Kshirsagar et al., filed Jan. 27, 2025, titled Artificial Intelligence Agent Architecture in a Database System”, which is hereby incorporated by reference in its entirety and for all purposes.

According to various embodiments, as AI models became more sophisticated, they became integrated into autonomous agents. Such autonomous agents act as intelligent assistants, capable of understanding and responding to user queries in natural language. Autonomous agents can perform a range of tasks, from providing information to completing complex actions. Autonomous agents are often oriented around a conversational interface and employ an AI agent as the central intelligence. They provide for increased user autonomy and have expanded capabilities beyond task-specific functions.

Various embodiments described herein now provide for a platform that supports multiple agents. Agents may facilitate retrieval augmented generation, topic filtering, headless interfaces, and other complex features. Such agents can operate independently without a user interface, proactively identifying and executing tasks based on predefined goals or real-time data. They can integrate seamlessly with various systems and applications to optimize processes and achieve desired outcomes. Agents can support features such as proactive task initiation and execution, integration with multiple systems, continuous learning and improvement, and automation of complex workflows.

According to various embodiments, different agents may possess different capabilities and knowledge, collectively contributing to the system's overall intelligence. For example, one agent may specialize in data analysis, while another focuses on natural language processing.

In some embodiments, communication by agents can be powered by generative language models. Generative language models can facilitate seamless communication and collaboration among agents, allowing them to share information, coordinate actions, and/or make collective decisions.

In some embodiments, different agents may employ a shared context, which provides a common understanding of the environment, goals, and constraints involved in performing a task. The shared context helps to ensure that different agents can coordinate work towards a unified objective.

In some embodiments, different levels of AI models may be supported in the system. At the lowest level, embedded AI models may perform specific, predefined functions such as generating emails, service replies, work summaries, predicting outcomes based on structured data, classifying input, and the like. At the highest level, an agent can operate independently and autonomously, making decisions and taking actions based on its knowledge and the shared context. This autonomy allows the system to adapt to changing conditions and handle complex tasks. An autonomous agent can move beyond reactive responses and can proactively identify opportunities, anticipate user needs, and initiate actions without explicit prompts. Non-autonomous agents can provide a bridge between embedded AI applications and autonomous agents, facilitating the expansion of their capabilities. By understanding user interactions and preferences, non-autonomous agents can gather valuable data to refine AI models and algorithms, paving the way for greater autonomy.

As one example of an autonomous agent, consider the challenge that conventional sales pipelines are bogged down by time-consuming, inaccurate, and inefficient processes. Sellers spend excessive hours prospecting to generate leads, often employing a scattershot approach that yields low conversion rates. Techniques and mechanisms described herein provide for an autonomous agent configured as a sales development representative that works tirelessly to boost pipeline velocity. The autonomous agent rapidly prioritizes leads, grows pipelines, and reduces manual workload, providing a unified approach to sales orchestration across direct, indirect, and self-service channels.

As another example of an autonomous agent, consider the challenge that sales teams and representatives would like to improve performance and achieve sales targets. Techniques and mechanisms provide for a sales manager coach that offers real-time, data-driven performance analytics, coaching tools, recommendations, and performance metrics for both sales representatives and managers.

As another example, consider the challenges faced by many manufacturing companies, where procurement is in a silo, isolated from manufacturing and also completely disconnected from a customer relationship management system. Accordingly, many procurement organizations manually acquire parts, products, and supplies. Procurement departments are therefore often working with dated information, and are not processing real-time requests from CRM and Manufacturing. To address these problems, an autonomous agent may be configured. Consider the example of a requirement to acquire four specially built tires. Procurement sends an autonomous agent to search for the four tires and autonomously sources them if it finds them. If the autonomous agent can't find them, then it autonomously schedules a production run for the 4 tires, and reaches out to sales to notify the customer about lead time. Data connectors can gather the data sources and provide the data required to identify the available sources, capacity of the production line, and demand. Procurement can either source the part itself or source by the bill of materials. The autonomous agent in the sales dept could also communicate with procurement to procure the required materials and products. Other data sources may include information such as weather, anticipated demand for products, and/or anticipated product failures due to customer neglect (e.g., failure to perform maintenance). Thus, an autonomous agent may combine generative language models with other types of AI models, such as prediction models, a configuration referred to as “blended AI.”

More generally, according to various implementations, the models and/or modules described herein may include classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

According to various embodiments, techniques and mechanisms described herein address a variety of technical challenges, such as adapting generative language models to integrate with computing services environments. Computing services environment provide various types of computing services from a service provider to various client organizations. Examples of such services include, but are not limited to, those directed to customer relations management, sales relations management, supplier relations management, and database management applications. Autonomous agents may help to connect the power and flexibility of generative language models with the power and flexibility of computing services environments. However, existing approaches to autonomous agent configuration and implementation involve manually configuring autonomous agents to perform particular tasks. Such an approach suffers from various drawbacks, such as lack of testability, lack of extensibility, significant development delay, and more. In contrast, techniques and mechanisms described herein provide a set of architectures, frameworks, and methodologies facilitating autonomous agent development and implementation that in various embodiments are extensible, automatable, automated, flexible, and integrated with various computing services environment and generative language model platforms.

According to various embodiments, a computing services environment includes a wide variety of computing services arranged across a wide variety of computing devices in communication with one another. Likewise, a generative language model includes many neurons (e.g., millions, billions, or more) arranged in complex neural networks configured to perform sophisticated generative tasks. Coordinating between such systems involves a host of operations, including those related to processing, communication, architecture, coordination, monitoring, feedback, auditing, logging, and more. Any method performed by a system operating at the intersection of a computing services environment and a generative language model is, therefore, necessarily incapable of being performed in the human mind. In such a context, even a seemingly simple operation involves such a wide range of computing resources that a human mind would be incapable of performing the operation in the context of a method or system implemented as described herein. For example, although a human mind is capable of generating text, the human mind is incapable of executing a generative language model to generate text to complete a prompt specified in accordance with one or more embodiments.

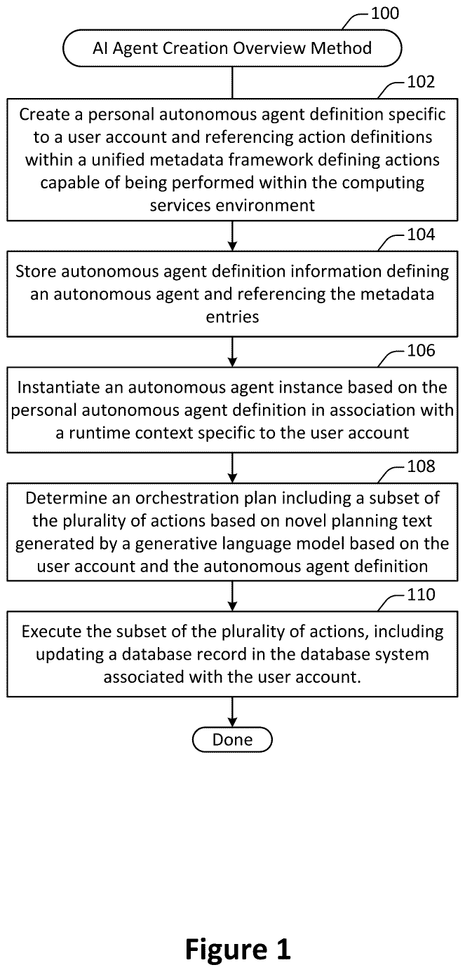

FIG. 1 illustrates an autonomous artificial intelligence agent creation overview method 100, performed in accordance with one or more embodiments. According to various embodiments, the various operations shown in FIG. 1 may be performed in the course of configuring, instantiating, and executing an autonomous artificial intelligence agent (referred to herein as an autonomous agent). The method 100 may be performed at a computing services environment.

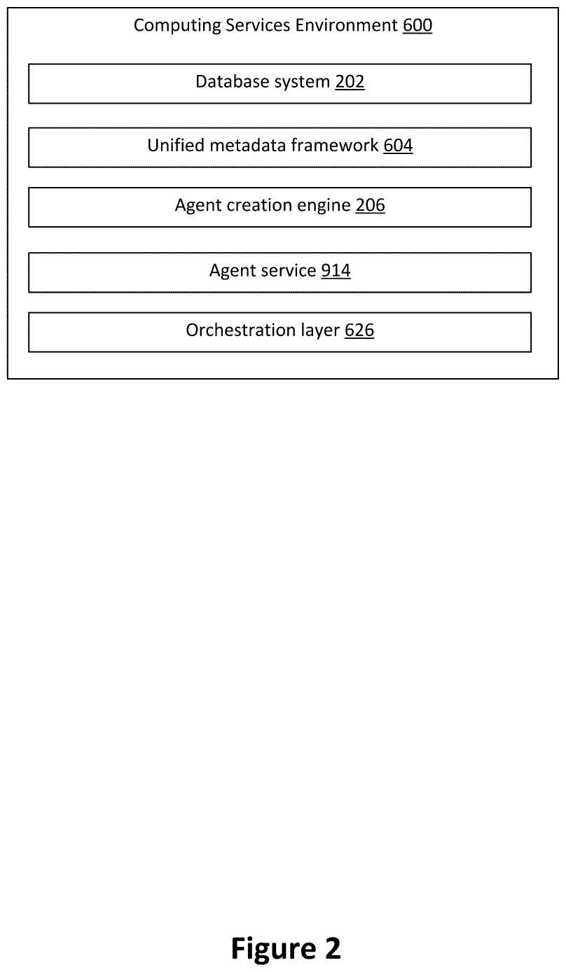

The method 100 is described partially in reference to FIG. 2, which illustrates various elements that may be included within a computing services environment 600. The computing services environment 600 includes a database system 202, a unified metadata framework 604, an agent creation engine 206, an agent service 914, and an orchestration layer 626.

Computing services environments are typically quite complex and include many components working in concert. Although not all of those components are described in this application so as not to obscure the various concepts, additional details regarding various other components that may be included within the computing services environment 600 are shown in FIG. 6, and particularly those components pertinent to the configuration, provisioning, instantiation, and execution of autonomous agents.

A personal autonomous agent definition is created at 102. According to various embodiments, the personal autonomous agent definition may be created within the context of a computing services environment providing computing services to entities via application servers. The computing services may include access to the database system 202 hosted within the computing services environment. The personal autonomous agent definition may be specific to a user account within the computing services environment and may reference action definitions within a unified metadata framework defining actions capable of being performed within the computing services environment.

According to various embodiments, the personal autonomous agent definition may include metadata entries stored in accordance with the unified metadata framework 604. The unified metadata framework 604 may provide a structure for defining resources used to create agents. Various types of resources may be included in an autonomous agent definition. For example, prompt templates may be used to create prompts to provide to generative language models. As another example, action definitions may support the selection and performance of actions such as retrieving data, storing data, generating text, and/or other types of actions executable within the computing services environment. As yet another example, orchestration information may be used to select and implement orchestration plans for selecting actions appropriate to a particular situation being handled by an instance of the autonomous agent. Hence, the metadata entries included within the personal autonomous agent definition may facilitate linking the actions performed within the computing services environment with an autonomous agent definition. In this way, the actions may be selected and executed during the execution of an autonomous agent instantiated based on the autonomous agent definition.

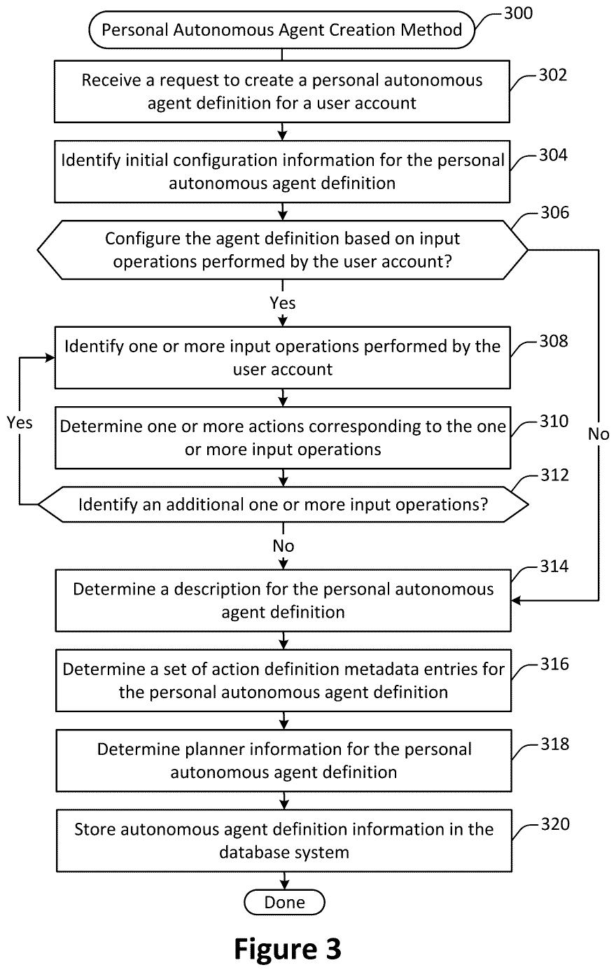

In some implementations, the personal autonomous agent definition may be created via an agent studio provided by the agent creation engine 206 shown in FIG. 2. The personal autonomous agent definition may be created based on configuration information. Configuration information may be manually provided via a graphical user interface generated by the agent studio. Alternatively, or additionally, configuration information may be determined by the agent studio. For instance, the agent studio may monitor actions taken by the user account within the computing services environment and then elements of the autonomous agent definition based on those actions. Such elements may include topics, actions, planner configuration information, and the like. Additional details regarding the creation of the personal autonomous agent definition are discussed with respect to the method 300 shown in FIG. 3.

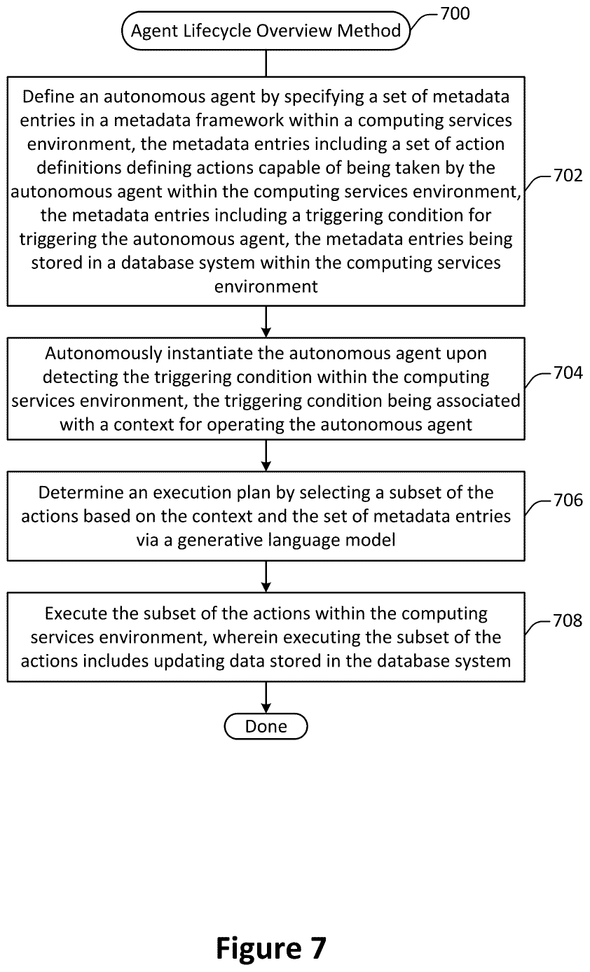

An autonomous agent instance is instantiated at 104 based on the personal autonomous agent definition. In some embodiments, the autonomous agent instance may be instantiated via the agent service 914 shown in FIG. 2. The autonomous agent instance may be associated with a runtime context specific to the user account. Instantiating the autonomous agent may involve one or more operations related to provisioning the autonomous agent instance, determining an initial context for the autonomous agent instance, and the like. Additional details regarding such instantiation are discussed with respect to the method 700 shown in FIG. 7.

An orchestration plan is determined at 108. According to various embodiments, the orchestration plan may include a subset of the actions determined based on novel based on novel planning text generated by a generative language model. The novel planning text may be generated based on the user account and the autonomous agent definition. The orchestration plan may be determined by the orchestration layer 626 shown in FIG. 2.

In some implementations, one or more of the actions included in the orchestration plan may be selected from actions included in the personal autonomous agent definition. Such actions may be identified and/or created as discussed with respect to the operations 102 through 106. However, not all actions included in the personal autonomous agent definition need be performed by any particular autonomous agent instance. Further, actions selected for performance may include actions other than those created via the creation process. For instance, one or more default or standard options available via the computing services environment may be selected for performance.

The subset of the actions is executed at 110. Executing an action may involve, for instance, updating a database record in the database system associated with the user account.

### Systems and Processes for Creating and Executing a Personal Autonomous Agent

FIG. 3 illustrates a method 300 for creating a personal autonomous agent, performed in accordance with one or more embodiments. The method 300 may be performed at the computing services environment 200 shown in FIG. 2.

A request to create a personal autonomous agent definition for a user account is received at 302. In some embodiments, the request may be generated based on user input. For instance, the user may navigate a graphical user interface associated with an agent studio and provide user input indicating that the user would like to create a personal autonomous agent.

In some embodiments, the request may be generated automatically by the computing services environment. For instance, the agent platform may monitor operations performed by the user account within the computing services environment, such as user input received from a client machine authenticated to the user account. The user input may involve, for instance, clicking on affordances included in user interfaces generated by an application server, entering text, transmitting API requests, and/or other such operations. Based on such operations, the agent platform may identify a recurring pattern of operations suitable for use in autonomously creating a personal autonomous agent definition, and then autonomously generate the request to create the personal autonomous agent definition.

Initial configuration information for the personal autonomous agent definition is identified at 304. According to various embodiments, the initial configuration information may include elements such as an agent name, an identifier associated with the user account, one or more triggering conditions the detection of which triggers instantiation of the personal autonomous agent, and/or other such information.

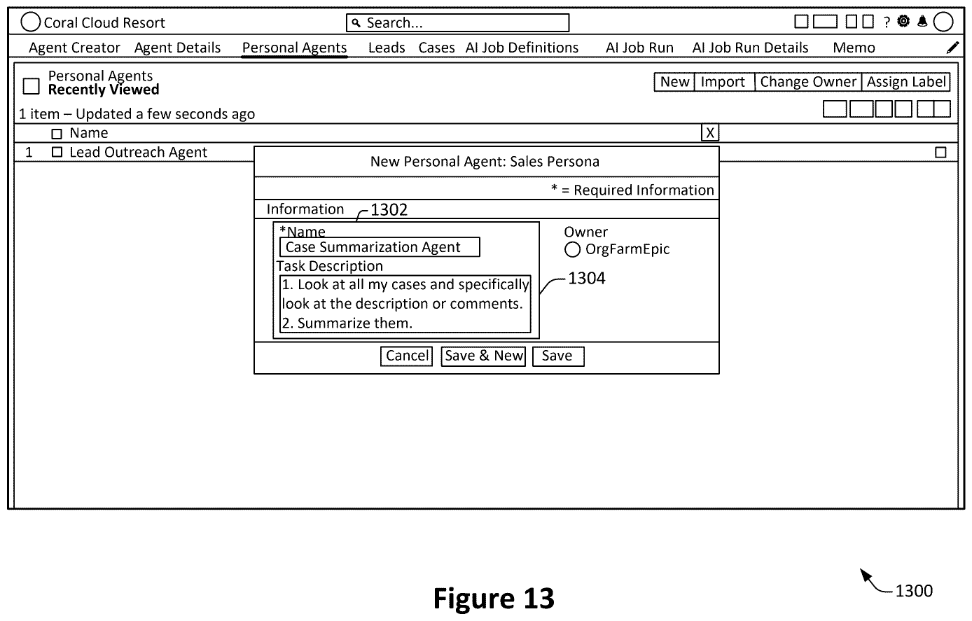

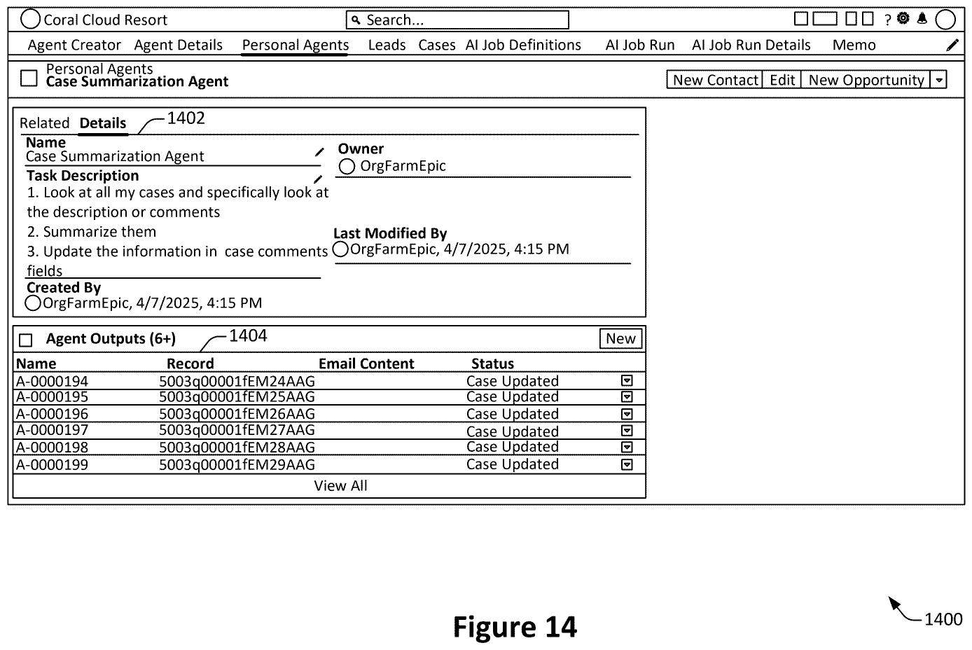

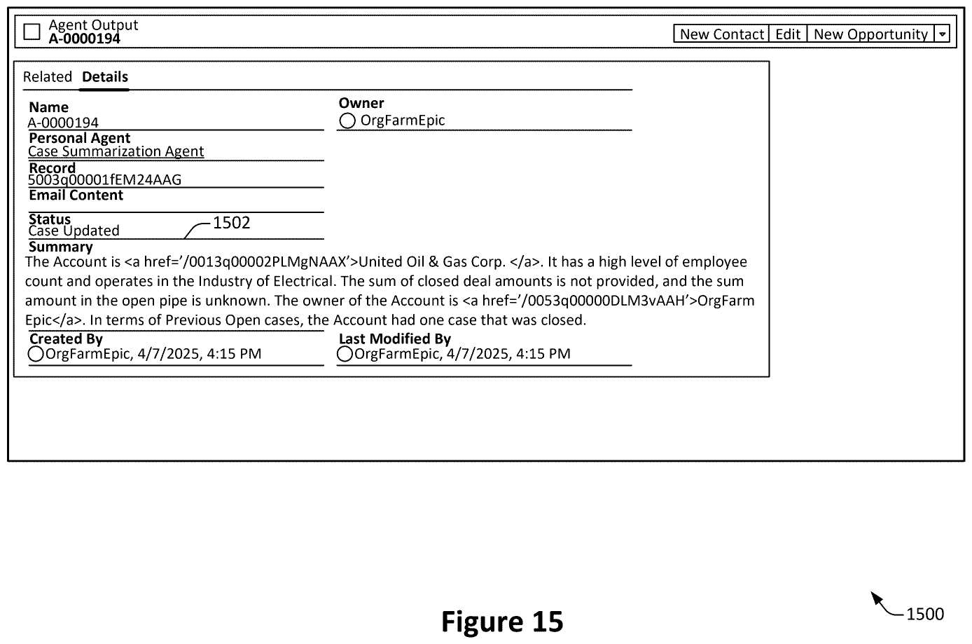

In some embodiments, some or all of the initial configuration information may be provided based on user input. For instance, as shown in the user interface 1300 in FIG. 13, the agent's name may be provided via user input at 1302. The name for the agent may characterize the agent's function, such as “Technology Leads Agent” or “Case Summarization Agent”.

Alternatively, or additionally, some or all of the initial configuration information may be determined autonomously. For instance, a generative language model may analyze a pattern of operations and generate novel text that includes a name for the personal autonomous agent definition. As still another possibility, one or more configuration parameters may be specified in a different way, such as being retrieved from configuration data, specified via markup, or received via an application procedure interface.

In some implementations, the configuration parameters may include one or more parameters specifying conditions associated with the personal autonomous agent definition. For example, a parameter may specify one or more triggering conditions for instantiating the personal autonomous agent definition, a frequency with which the personal autonomous agent definition is to be instantiated, and/or one or more guidelines governing operation of the personal autonomous agent definition.

A determination is made at 306 as to whether to configure the personal autonomous agent definition based on input operations performed by the user account. According to various embodiments, the input operations may include user input received from a client machine authenticated to the user account. For instance, such operations may be generated by the user associated with the user account interacting with user interfaces provided to the client machine from an application server within the computing services environment.

In some embodiments, the determination made at 306 may be made based on user input. For instance, the user may proceed to providing input for the description of the personal autonomous agent definition. Alternatively, the user may provide user input requesting that the personal autonomous agent definition be created based on input operations.

In some embodiments, the determination made at 306 may be made autonomously. For instance, as discussed with respect to the operation 302, the request to create the personal autonomous agent definition may be autonomously created based on a recurring pattern of operations identified by the computing services environment.

Upon determining to identify input operations, one or more input operations performed by the user account are identified at 308. In some embodiments, input operations may be generated after the determination is made to identify such operations. For instance, the user associated with the user account may provide user input indicating a desire to perform a sequence of input operations used as a basis for determining the autonomous agent definition.

In some embodiments, input operations may be generated before the determination is made to identify such operations. For instance, a user associated with a user account may interact with the computing services environment over a period of time, for example by providing user input via graphical user interfaces provided to a client machine via an application server at the computing services environment. The operations associated with such user input may then be logged for subsequent analysis, such as by recognizing patterns of actions reflected in the operations.

One or more actions corresponding to the one or more input operations are determined at 310. In some embodiments, the one or more actions may be identified by selecting, organizing, grouping, and/or otherwise processing input operations into units corresponding with action definitions. For instance, a user may perform a sequence of operations such as clicking on a representation of a database record, clicking on a summary field within the database record, providing text summarizing the database record, and clicking on a save button. Such operations may be analyzed to identify one action to generate text summarizing a database record and another action to update the database record to include the generated text.

In some embodiments, the one or more actions may be identified based on output provided by a generative language model. For instance, a generative language model may be provided with a description of a sequence of operations and descriptions of various action definitions, along with natural language instructions to identify one or more action definitions characterizing the sequence of operations. The generative language model may then generate novel text that includes identifiers corresponding to a selected set of action definitions.

A determination is made at 312 as to whether to identify an additional one or more input operations. In some embodiments, additional input operation may continue to be identified until a terminating condition is met. For example, in the case of a sequence of operations being recorded based on real time user input, the user may provide user input indicating that the sequence is complete. As another example, in the case of a pattern of previously performed and logged operations being analyzed to create the personal autonomous agent definition, additional input operations may continue to be selected until the input operations included in the identified pattern have been analyzed.

Upon determining not to identify additional input operations, or upon determining not to configure the autonomous agent definition based on input operations, a description for the personal autonomous agent definition is determined at 314. In some embodiments, the description may be determined based on user input provided as natural language, for instance as shown at 1304 in FIG. 13. For example, the user input may specify a sequence of tasks to be performed by the agent, such as “1. Look at all my cases and specifically look at the description or comments. 2. Summarize them and update the summaries.” As another example, for a “Technology Leads Agent”, the description may include text such as “Get all of my technology leads and send emails to them.”

In some embodiments, the description may be determined automatically, for example based on novel text generated by a large language model. For instance, the LLM may be provided with a prompt that includes the one or more actions determined at 310 and/or the initial configuration information identified at 304. The LLM may then complete the prompt by producing novel text that serves as a description of the agent.

A set of action definition metadata entries are determined for the personal autonomous agent definition at 316. In some embodiments, an action definition metadata entry may uniquely identify an invocable action that may be performed within the computing services environment. For instance, an action may correspond to sending a message, determining text, updating a database field, retrieving data from a data source, or any other such operation.

According to various embodiments, the specific actions may depend on the particular input used to create the personal autonomous agent. For example, for a “Technology Leads Agent”, the actions may include: (1) a data retriever to retrieve all “Lead” database objects of type “Technology” that are assigned to the user account, and (2) an email action that includes a prompt suitable for sending to a generative language model for generating an email based on the lead. As another example, for a “Case Summarization Agent”, the actions may include: (1) a data retriever to retrieve all Case database objects assigned to the user account; (2) a record summarization action to summarize the content of the case database objects via a call to a generative language model, and (3) a data record updating action configured to store the summary.

In some embodiments, an action definition metadata entry may be identified by a generative language model. For instance, a large language model may be provided with an input prompt that includes information such as the description of the personal autonomous agent and/or other configuration information. The prompt may also include a list of action identifiers and action descriptions from which the generative language model can select, and natural language instructions to select a set of action identifiers based on the configuration information. For example, the prompt may include one or more natural language instructions to identify actions suitable for executing the intent reflected in the description. The LLM may then complete the input prompt by generating novel text that includes unique identifiers corresponding to the actions selected by the LLM.

In some embodiments, the generative language model may be configured to interpret natural language input to accurately identify actions within the system. For example, an LLM may determine that terms such as “opportunities” or “deals” as used in natural language refers to an Opportunity database object accessible via the database system. As another example, the LLM may determine that phrases such as “send a message” and “contact them” both refer to emails in the context of a particular natural language instruction.

In some embodiments, an action definition metadata entry may be determined based on user input. For instance, the user may be provided with one or more potential actions that may be performed by the agent and then provide a selection as to which of the potential actions is to be included in the autonomous agent definition.

In some embodiments, an action definition metadata entry may be determined based on input operations. For instance, as discussed with respect to the operation 310, input operations may be analyzed to identify actions corresponding to the input operations. Then, action definition metadata entries corresponding to those actions may be identified.

In some embodiments, an action definition may be created or customized by a generative language model. For example, an LLM may create a new data retriever. As another example, an LLM may customize an existing action for sending an email with a prompt template that is specific to the personal autonomous agent being created. For instance, the prompt template may include instructions or example language that reflects the style and/or preferences of the user associated with the user account.

In some embodiments, determining an action definition may involve determining configuration information for the action definition. For instance, a preconfigured action definition may involve retrieving information from the database system. Including such an action definition within the personal autonomous agent definition may involve determining a suitable query to use in conjunction with the action definition. The query may be determined by the generative language model by evaluating the autonomous agent description, the one or more input operations, and/or other configuration information.

Planner information for the personal autonomous agent definition is optionally determined at 318. In some embodiments, the planner information may include any information suitable for configuring a planner for the personal autonomous agent. For example, the planner information may include a selection of a particular planner from a set of predetermined planners. As another example, the planner information may include a planner graph identifying ordering of actions and/or one or more conditions for performing actions associated with the autonomous agent definition.

Personal autonomous agent definition information is stored in the database system at 320. The personal autonomous agent definition information may include metadata entries configured and stored in accordance with the unified metadata framework and in association with the user account.

According to various embodiments, one or more of the operations described herein may be performed based on novel text generated by an LLM. An example of a prompt suitable for generating novel text in the context of a particular computing services environment are provided below:
Your job is to create a description of an AI Agent, generating sample utterances, and convert a list of topics into a specific JSON format. The description of the AI Agent and the sample utterances should be combined into the JSON object. The description and sample utterances should be grounded in the context of the conversation provided.
#Rules:
When converting the Topics, classificationDescription, scope, instructions and actions to JSON, DO NOT MODIFY any of the properties or language.
Never use or include emojis
#Guidelines Follow these instructions carefully to complete the task:
1. Examine the list of jobs to be done along with description as define in this spec {!$Input:AgentDetail__c.Spec__c} and then do step 3.
2. Use the {!$Input:AgentDetail__c.AgentType__c} as necessary to pick the right topics as needed.
3. Convert each topic into the required JSON format using the following structure: [{“Topic”: “[Topic Name]”, “ClassificationDescription”: “[Your 1-2 sentence description here]”, “Scope”: “[Your specific job-to-be-done of the topic here. 1-3 sentences]”, “Instructions”: [List of instructions] , “Actions”: [list of actions]}]
4. For each topic:
   a. Use the topic name as provided in the list for the “Topic” field.
   b. Use the classification description provided in the ClassificationDescription field. Do not change the classification description.
   c. Use the scope provided in the scope field. Do not change the scope.
   d. Include all of the instructions provided in the instructions list. Do not change any of the instructions
   e. Generate a list of actions for the “Actions” field, following the format described in step 5. Do not change any of the action properties.
   f. Ensure you do not change the fields from the Topics
   g. Remove all ‘/’ from the actions.
   h. Remove any actions that do Knowledge Lookups or search knowledge action. This includes but is not limited to: Knowledge_Lookup, Search_Knowledge . . . etc. If an instruction includes the “Knowledge_Lookup” action, modify the instruction to something like “search the knowledge base”.
5. For each action, generate an example_output as a JSON object that demonstrates its full capabilities. Rules for the example output:
   a. Provide a detailed and realistic return value b. Include any relevant metadata or additional information that the function might reasonably return.
6. Format each action in the “Actions” list as follows: {“action_name”: <descriptive_action_name>, “inputs”: [{“inputName”: <input_name>, “input_description”: <input_description>, “input_dataType”: <input_dataType>}], “outputs”: [{“outputName”: <output_name>, “output_description”: <output_description>, “output_dataType”: <output_dataType>}], “action_description”: <1-2 sentence description of what the action does >“example_output”: <the generated example of the output of the action>}
7. Given the Topics and the Context of the conversation, generate a 1-2 description of the AI Agent and what it does. The description should start with: “You are an AI Agent whose job is to help {!$Input:AgentDetail__c.CompanyName__c} {!$Input:AgentDetail__c.AgentType__c} . . . ”
8. Given the Topics, Instructions, and actions, generate 4-5 sample utterances a user might use to engage with the AI Agent. These sample utterances should tie directly back to an instruction or an action. When including IDs in the sample utterances, make the IDs realistic. Do not include any utterances about escalating or speaking to a human.
9. Ensure that all JSON is properly formatted and valid. Always return only JSON.

Another example of a prompt is provided below:
You are an AI assistant that automates tasks in Salesforce by generating a sequence of actions based on user requests. You are provided with the following actions, their inputs, and descriptions:
1. **Action:**‘QueryRecords(soqlQuery)’
**Description:**Executes a SOQL query to retrieve records from Salesforce.
**Inputs:**
‘soqlQuery’ (string): A SOQL query string to specify the records to retrieve.
**Outputs:**
‘record’ (string): List of record ids
2. **Action:** ‘EmailGeneration(leads, prompt)’
**Description:** Generates personalized email content for a list of leads based on a given prompt.
**Inputs:**
‘leads’ (list): A list of lead records to tailor the email content.
‘prompt’ (string): Instructions or context to generate the email content.
**Outputs:**
‘emailContent’ (list): List of content based on each of the leads
3. **Action:** ‘SendEmail(emailContent, recipients)’
**Description:** Sends an email with the specified content to the given recipients.
**Inputs:**
‘emailContent’ (list): The content of the email to send for each recipient.
‘recipients’ (list): A list of email addresses to send the email to.
**Outputs:**
‘status’ (list): List of status for each record
4. **Action:** ‘SummarizeCase(cases)’
**Description:** Summarizes the case information
**Inputs:**
‘cases’ (list): The list of cases to be summarized.
**Outputs:**
‘summary’ (list): List of summarized content
5. **Action:** ‘UpdateCaseSummary(cases, summary)’
**Description:** Summarizes the case information
**Inputs:**
‘cases’ (list): The list of cases to be updated
‘summary’ (list): list of summary to be updated
**Outputs:**
‘status’ (list): List of success status
*Your Task:**
Based on the following user request, use **Tree of Thought (ToT)** reasoning to determine the necessary actions and their sequence to complete the task. **Tree of Thought reasoning involves exploring multiple possible reasoning paths (branches) to consider various action sequences, evaluating their potential outcomes, and selecting the most effective sequence to achieve the user's goal.**
Ensure the actions chain properly, and each action's inputs are correctly derived from previous steps or provided as constants.
**Document your reasoning process**, outlining the different paths considered and the rationale for choosing the final action sequence. Output the final plan as a valid JSON structure with the appropriate steps and inputs.
**User Request:**
{!$Input:User_Query}
**Instructions:**
1. **Analyze the User Request:**
Break down the request into specific goals and sub-tasks.
Identify key entities (e.g., technology leads, outreach email).
2. **Generate Possible Action Sequences (Tree of Thought):**
Consider different sequences of actions that could fulfill the request.
Explore alternative approaches and the implications of each path.
For each path, determine how the actions would connect and what inputs are required.
3. **Evaluate and Select the Best Action Sequence:**
Assess the feasibility, efficiency, and completeness of each action sequence.
Choose the sequence that best satisfies the user's request with the most effective use of actions.
4. **Output the Final Plan:**
Present the selected sequence of actions in a JSON structure named ‘steps’.
Each step should include the ‘action’ name and its ‘input’ parameters.
Ensure that all inputs are correctly specified and that outputs from previous steps are properly referenced.
5. ALWAYS return the output as a valid JSON. You should only return json output and no extra information
**IMPORTANT**
You should only return Json as define below. DO NOT return any extra information. Follow this as strictly as possible
**Example Output Format:**
‘‘‘json
{
“steps”: [
{
“action”: “actionName”,
“input”: {
“parameter1”: “value1”,
“parameter2”: “value2”
}
},
{
“action”: “nextAction”,
“input”: {
“parameterA”: “{{actionName.outputValue}}”
}
}
// . . . additional steps as needed
]
}
‘‘‘

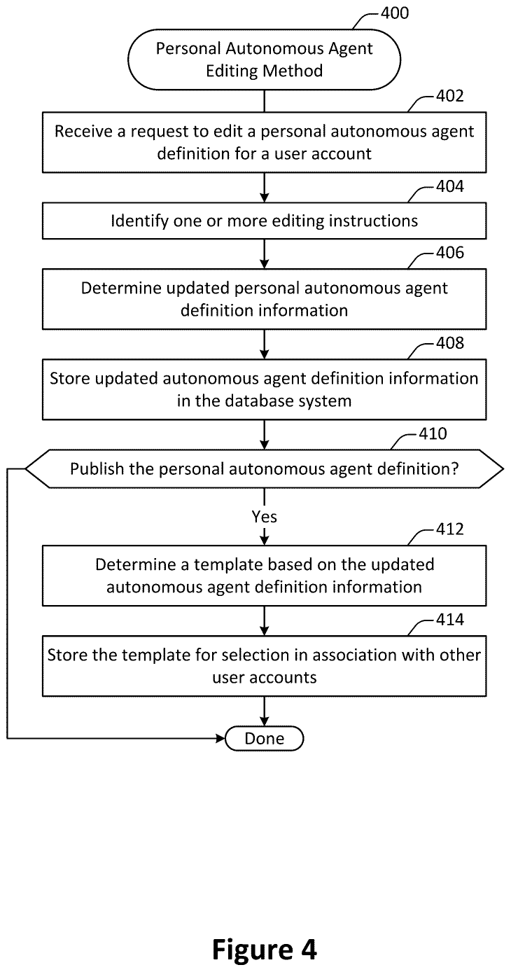

FIG. 4 illustrates a method 400 for editing a personal autonomous agent, performed in accordance with one or more embodiments. The method 400 may be performed at a computing services environment such as the computing services environment 200 shown in FIG. 2.

A request to edit a personal autonomous agent definition for a user account is received at 402. In some embodiments, the request may be received via a user interface associated with an agent creator.

One or more editing instructions are identified at 404. In some implementations, an editing instruction may be received via natural language input. For instance, the user associated with the user account may provide a natural language instruction to modify the agent. Alternatively, an editing instruction may be received via user input provided via a graphical user interface.

According to various embodiments, various types of editing instructions may be received, including any type of change to potentially any element of the personalized autonomous agent definition. An editing instruction may add an action to the personal autonomous agent definition, remove an action from the personal autonomous agent definition, modify one or more elements of a planner associated with the personal autonomous agent definition, change a description of the personal autonomous agent definition, and/or perform any other such operations.

Updated personal autonomous agent definition information is determined at 406 and stored in the database system at 408. According to various embodiments, the updated definition information may be determined as stored in a manner similar to that discussed with respect to the operations 304 through 320 shown in FIG. 3.

A determination is made at 410 as to whether to publish the personal autonomous agent definition. In some embodiments, the determination may be made based on user input. For instance, a user that has configured a personal autonomous agent for use in association with a user account may decide to make the personal autonomous agent available for use by other users.

Upon determining to publish the personal autonomous agent definition, a template is determined based on the updated autonomous agent definition information at 412. In some embodiments, the template may be similar to the autonomous agent definitions stored to the database for the user account, except stripped of any account-specific information.

The template is stored at 414 for selection in association with other user accounts. For instance, users may select the personal autonomous agent definition template for association with their user accounts in a personalized fashion by accessing the template via a user interface that provides access to preconfigured autonomous agents.

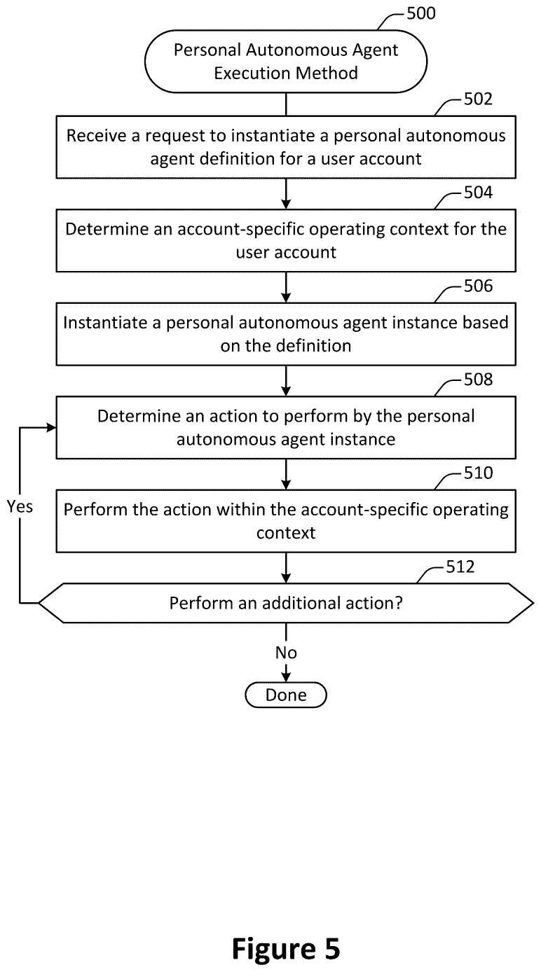

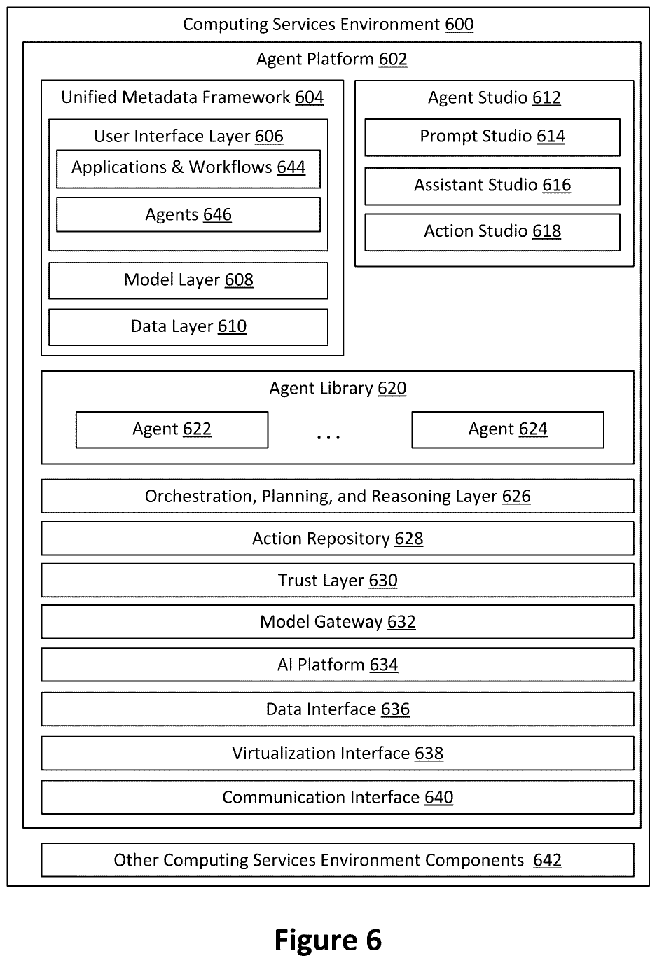

FIG. 5 illustrates a method 500 of instantiating and executing a personal autonomous agent, performed in accordance with one or more embodiments. The method 500 may be implemented on a computing services environment such as the computing services environment 200 shown in FIG. 2. The method 500 illustrates various operations related to autonomous agent instantiation and execution focused on account-specific contexts. Such operations are discussed in a more general context with respect to the method 700 shown in FIG. 7.

A request to instantiate a personal autonomous agent definition for a user account is received at 502. In some embodiments, the request may be generated based on user input. For instance, the user may select the personal autonomous agent definition from a user interface providing access to preconfigured autonomous agents or provide a natural language request to instantiate the autonomous agent via a chat interface. Alternatively, the request may be generated automatically, for instance upon detection of a triggering condition.

An account-specific operating context for the user account is determined at 504. According to various embodiments, the account-specific operating context may include one or more authorizations, permissions, preferences, configuration information, and/or other data specific to the user account. For example, the account-specific operating context may include one or more natural language examples used to generate text in accordance with a style specific to the user account. As another example, the account-specific operating context may include one or more account-specific instructions governing text generation by an LLM in association with the user account. The account-specific contextual information may be retrieved from the database system associated with the computing services environment 200.

According to various embodiments, the runtime context may identify the user account so that data retrieval queries and other such actions may be performed in an account-specific manner. For example, the personal autonomous agent may retrieve all records of a particular type that are assigned to the user account rather than all records of the particular type for the entire client organization.

A personal autonomous agent instance is instantiated at 506 based on the definition. Additional details regarding the instantiation of an autonomous agent are discussed with respect to the operation 704 shown in FIG. 7.

An action to perform by the personal autonomous agent instance is determined at 508. The action is performed within the account-specific operating context at 510. In some embodiments, the action may be determined based on an orchestration plan determined for the personal autonomous agent instance. The specific details of the orchestration plan, including the actions to perform, may be determined based on the definition and any information included in the context determined at 504. For instance, an instance of the agent configured as shown in FIG. 13 may first execute an action to retrieve opportunity objects associated with the user account, then execute one or more actions to determine summaries for those objects, and finally execute one or more actions to update the database records to reflect the updated summaries.

In some embodiments, the action may be determined in an account-specific manner. For example, when retrieving objects from the database system, the autonomous agent may select and receive only those objects assigned to the user account. As another example, when generating text via an LLM, the autonomous agent may generate text in accordance with style preferences associated with the user account.

An example of the performance of actions by a personalized autonomous agent is shown in FIG. 14. At 1402, configuration information for a case summarization information configured is shown. At 1404, logging information is shown illustrating the updating of the various database records for the user account by the autonomous agent.

A determination is made at 510 as to whether to perform an additional action. In some embodiments, the determination may be made based on evaluating whether all of the actions in the orchestration plan have been performed. In some configurations, a reasoning engine may evaluate output produced by performing the actions and determine whether the performance of additional actions is indicated and/or whether to update the orchestration plan.

### Agent Platform Overview

FIG. 6 illustrates a computing services environment 600, configured in accordance with one or more embodiments. The computing services environment 600 includes an agent platform 602 and other computing services environment components 642. The agent platform 602 includes a unified metadata framework 604, an agent studio 612, an agent library 620, an orchestration, planning, and reasoning layer 626, an action repository 628, a trust layer 630, a model gateway 632, an AI platform 634, a data interface 636, a virtualization interface 638, and a communication interface 640. The agent library 620 includes the agents 622 through 624. The unified metadata framework 604 includes a user interface layer 606, a model layer 608, and a data layer 610. The agent studio 612 includes a prompt studio 614, an assistant studio 616, and an action studio 618.

According to various embodiments, the unified metadata framework 604 may facilitate the configuration of agents as well as interactions between various elements of the computing services environment 600 and the autonomous agent platform 602. For instance, various operations, data objects, and other resources within the computing services environment 600 may be defined as metadata entries within the unified metadata framework 604. Agents may then be constructed using those metadata entries as building blocks.

In some embodiments, the user interface layer 602 facilitates the specification of various applications and workflows 644. Such applications and workflows may include operations performed within and/or outside of the computing services environment 600. For example, applications and workflows may be specific to types of services provided via the computing services environment 600, such as sales, service, marketing, commerce, data analysis, and the like. As another example, applications and workflows may include domain-specific operations, such as those specific to healthcare, finance, or other industries.

In some embodiments, the user interface layer 602 facilitates the specification of agents 646 such as conversational chat assistants. For example, the computing service environment 600 may provide one or more standard conversational chat assistants that may be accessed through user interfaces provided via the computing services environment 600 or via other communication channels such as email, SMS, or external chat services. As another example, an autonomous agent may be customized by, for instance, an organization accessing computing services via the computing services environment 600.

In some embodiments, the agents 646 may be configured to perform various tasks within the system. Examples of agents may include, but are not limited to, customized agents, coaching agents, sales development agents, and customer service agents. Agents may be represented in the unified metadata framework 604 in the user interface layer 606 and may be stored in the agent library 620.

According to various embodiments, one or more of the agents may be autonomous AI agents. Autonomous AI agents (also referred to herein as autonomous agents) may be capable of autonomous or semi-autonomous activation and/or operation. However, not all AI agents are necessarily entirely autonomous. For instance, some AI agents may operate under human control and instruction, for instance eliciting human confirmation before performing some types of actions.

According to various embodiments, an agent may perform operations such as receiving user input, executing one or more applications, workflows, actions, or operations within the computing services environment 600, and/or interacting with a database system, generative language model, other artificial intelligence models, and/or other system accessible via the computing services environment 600.

According to various embodiments, the model layer 604 provides for secure interaction with one or more artificial intelligence models. For instance, the model layer may define access information for performing actions such as retrieving data and accessing AI models via the trust layer 630, the model gateway 632, the AI platform 634, and the data interface 636.

According to various embodiments, the trust layer 630 is configured to perform operations such as masking personally identifying information, securely retrieving data, detecting toxic language generated by a generative language model, and defending prompt completions against injection attacks and other attacks. Thus, the trust layer may provide additional protections for various actions performed in the context of various applications, workflows, and autonomous agents.

In some implementations, the data layer 606 defines data retrievers providing access to data sources, which may be located inside or outside of the computing services environment 600. Examples of such data sources may include, but are not limited to: structured data sources, unstructured data sources, data lakes, vector databases, relational databases, unified user profiles, data-based actions, data warehouses, and data lakehouses.

In some embodiments, an agent may be used to perform one or more tasks within the computing services environment 600. For example, an autonomous agent may interactively converse with a user in natural language. As another example, an agent may interact with one or more artificial intelligence models, including one or more generative language models, one or more predictive models, one or more classification models, and/or one or more other types of models. As yet another example, an autonomous agent may retrieve information from a database system, store information to a database system, transmit one or more messages, and/or take other actions within the computing services environment 600.

In some embodiments, the agent studio 612 allows for the construction and customization of various aspects of the agent platform 600 and/or agents accessible via the agent platform 600. The agent studio 612 may include elements such as a user interface, metadata information, monitoring, governance, and/or search tools for building agents. For example, the agent studio 612 may provide support for constructing one or more prompts, actions, applications, workflows, or the like.

The agent studio 612 includes a prompt studio 614, an assistant studio 616, and an action studio 618. According to various embodiments, the agent studio 612 provides functionality for the configuration of assistants, actions, and prompts to support agent platform customized for a customer organization. For example, a user may build, test, and integrate prompts, actions, and/or autonomous agents into one or more applications provided by or interoperating with the computing services environment 600 to support the performance of various tasks for an organization.

Agents 622 through 624 may be stored in the agent library 604. One or more agents may be configured in a standardized format and/or template for use by various organizations and individuals accessing computing services via the computing services environment 600. Additionally, one or more agents may be customized for particular industries, organizations, individuals, applications, and/or other contexts.

At 626, an orchestration, planning, and reasoning layer provides for the execution of an agent to interpret, decompose, and implement actions based on user inputs. For example, a user instruction such as “draft an email summarizing this record” may be analyzed to identify an overall intent. The user instruction may also be decomposed into actions such as “summarize a record” and “draft an email using the summary”. The decomposition and overall intent may be used to orchestrate and execute a plan, which may involve identifying the focal record, determining and completing one or more prompts to determine the summary, and determining and completing one or more prompts to draft an email using the summary. Additional details regarding the formulation and execution of such a plan are discussed throughout the application.

According to various embodiments, the action repository 628 may include one or more actions that are preconfigured to perform tasks within the computing services environment 600. For instance, an action repository may include actions such as “summarize a record” or “draft an email.” An autonomous agent may identify and execute such actions in order to implement a user's intent or accomplish other objectives assigned to the autonomous agent.

In some embodiments, one or more of the actions may be specific to a particular domain. For instance, one or more actions in the health or finance domains may include particular constraints, such as instructions provided to a generative language model, to provide for compliance with relevant laws and regulations.

In some embodiments, one or more of the actions may be configurable and/or user-defined. For instance, a user associated with an organization accessing computing services via the computing services environment 600 may provide code and/or other action definition information specifying an action to be performed. The defined action may then be incorporated into an orchestration or workflow.

The model gateway 632 provides access to one or more generative language models or other artificial intelligence models. In some embodiments, agents may be supported by a range of different generative language models. For example, a customer organization may be able to use standardized models provided by model providers such as Open AI, Microsoft Azure, Gemini, or the like. As another example, the model gateway 632 may also support customized models, for instance models customized and/or hosted by a customer organization. As yet another example, the model gateway 632 may provide access to models hosted within the computing service environment 600.

In some embodiments, an AI agent may be configured to employ different models for different aspects of the agent. For example, one model (e.g., Gemini) may be used for a function such as “summarize record”, while another model (e.g., Open AI) may be used for a function such as “draft email”. In this way, an AI agent may be flexibly adapted to execute a variety of different operations.

In some embodiments, the model gateway 632 may provide a feedback framework for receiving user feedback. The user feedback may be stored in the database and may be used for a variety of purposes, such as finetuning an autonomous agent and/or one or more of the underlying generative language models.

The AI platform 634 may provide support for generative language models and other types of AI models hosted by the service provider of the computing services environment 600 and/or one or more partner or customer organizations. For example, the customer organization may provide their own generative language model, such as a hosted generative language model. As another example, the customer may employ a customer-tuned version of a standard model, such as the customer's version of a model provided by Azure or Gemini. As still another example, an agent may employ a standard generative language model hosted by the service provider of the computing services environment 600.

The data interface 636 provides access to one or more of a variety of data sources. According to various embodiments, an agent may access one or more data sources to support the autonomous agent operations. For example, an agent may access third party data sources such as Google Cloud, Google BigQuery, Amazon S3, or Microsoft Azure. As another example, an agent may access one or more data sources from inside the computing services environment, such as customer relations management data. As still another example, an agent may access data from other sources, such as legacy systems, external apps, mobile sources, web sources, software development kids, and/or application procedure interfaces. Examples of data interfaces may include, but are not limited to: data lakehouses, real-time data services, zero-ETL data services, united profiles, data actions, data connectors, relational database systems, and any other interfaces for accessing structured, unstructured, or semi-structured data sources.

At 638, a virtualization platform provides for the ability to deploy one or more aspects of the platform provided via the computing services environment in one or more virtual environments. For example, data residency requirements may be enforced, ensuring that data resides in a particular location. As another example, communications may be encrypted end-to-end. As still another example, one or more regulatory requirements may be enforced. The virtualization platform 638 may allow all or a portion of the computing services environment 600 to be deployed in a different location, such as within a hosted environment (e.g., Google Compute, Amazon AWS, etc.).

The communication interface 640 facilitates communication with one or more client machines via any of various communication channels. For example, depending on the system configuration, a client machine may communicate with an autonomous agent via a web interface, a messaging application (e.g., Slack), email, voice, SMS messages, and/or any other suitable communication channel. Some such channels may be embedded into other applications, such as web applications accessible via the computing services environment 600 or native applications accessed via a client machine.

According to various embodiments, as shown in the other computing services environment components 642, the computing services environment 600 may include various elements and components other than those shown in FIG. 6.

FIG. 7 illustrates a method 700 providing an overview of the lifecycle of an autonomous agent, performed in accordance with one or more embodiments. According to various embodiments, the method 700 may be performed at a computing services environment such as the computing services environment 600 shown in FIG. 6.

At 702, an autonomous agent is defined by specifying a set of metadata entries in a metadata framework within the computing services environment. The metadata entries may be stored in a database system within the computing services environment. The metadata entries may include a set of action definitions defining actions capable of being taken by the autonomous agent within the computing services environment. The metadata entries may also include a triggering condition for triggering the autonomous agent.

In some embodiments, the agent and/or one or more of the actions may be defined by the service provider of the computing services environment. Alternatively, or additionally, the agent and/or one or more of the actions may be customized by a client accessing computing services via the computing services environment. In such a configuration, the customized autonomous agent may be specific to the client and may be unavailable to other clients accessing computing services within the computing services environment.

In some embodiments, an autonomous agent may be configured for operation within a portion of the computing services environment. For instance, the autonomous agent may be configured to operate within one or more on-demand computing applications, computing clouds, chat interfaces, operational contexts, data sets, data object types, or the like.

In some embodiments, the triggering condition may include an explicit request by a user to instantiate the autonomous agent. For instance, the autonomous agent may be instantiated based on one or more natural language user instructions received via a communication channel. Alternatively, or additionally, the triggering condition may specify one or more conditions under which the autonomous agent is autonomously instantiated. For example, the autonomous agent may be instantiated automatically when a database record is created or updated with a database field value that meets one or more defined characteristics. As another example, the autonomous agent may be instantiated automatically by a workflow within the computing services environment 600. As yet another example, the autonomous agent may be instantiated upon request as part of the execution of a different autonomous agent.

The autonomous agent is autonomously instantiated at 704 upon the detection of the triggering condition within the computing services environment. The triggering condition and hence the instantiation of the autonomous agent may be associated with a context for operating the autonomous agent. The context may specify one or more elements of an initial state of the autonomous agent. For instance, the context may identify information such as a client organization, a user account, natural language input received via a communication channel.

An execution plan is determined at 706 by selecting a subset of the actions based on the context. The execution plan may be determined by formulating a prompt for completion by a generative language model. The prompt may include information such as a set of action descriptions and action identifiers, as well as information associated with the context such as natural language user input. The prompt may include instructions to generate text including identifiers for actions that are selected by the generative language model based on the context, the instructions, and the action descriptions.

In some embodiments, determining the execution plan may involve multiple operations, executed in sequence or in parallel. For example, a particular planner and/or agent of a set of available planners and/or agents may first be selected. As another example, a topic or topics may be selected from a set of available topics, and the actions available for selection may be first filtered to the topic or topics. Such an approach may reduce the number of action descriptions that need to be included in the plan determination prompt that is completed by the generative language model to determine the plan.

The subset of actions are executed within the computing services environment 600 at 708. Executing the actions may involve performing any of a variety of operations. In particular, one or more data records stored within the database system within the computing services environment may be updated. Other examples of the types of operations that may be performed may include, but are not limited to: retrieving data from inside and/or outside the computing services environment, determining novel text, updating computing services environment logging data, executing one or more artificial intelligence and/or machine learning models inside and/or outside the computing services environment, transmitting messages to communicate with client machines and/or other devices, and the like. As discussed herein, an action may potentially include any operation or operations capable of being performed within the computing services environment.

The method 700 provides a general overview of the operations that may be performed in the lifecycle of an autonomous agent. Additional details regarding these operations, such as the creation of an autonomous agent, the instantiation of an autonomous agent, the determination of an execution plan, and the execution of the actions within an execution plan, are discussed throughout the application.

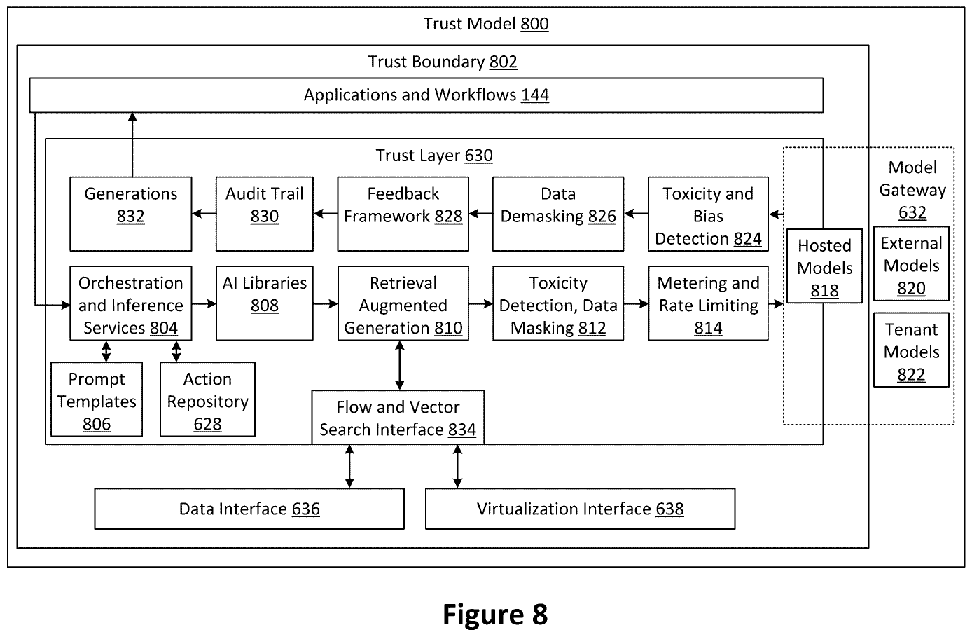

FIG. 8 illustrates a trust model 800 for the autonomous agent platform, configured in accordance with one or more embodiments. The trust model 800 includes a trust boundary 802. Inside the trust boundary 802 are the applications and workflows 644, the trust layer 630, the data interface 636, and the virtualization interface 638.

In some embodiments, the trust boundary 802 may separate internal from external services. Inside the trust boundary, at 630, a trust layer may provide for the execution of various trust related operations. Outside the trust boundary, one or more external services or models may operate in an untrusted zone or a zone of shared trust.

The trust layer 630 includes one or more orchestration and inference services 804, one or more artificial intelligence libraries 808, one or more retrieval augmented generation services 810, one or more inbound toxicity detection and/or data masking services 812, one or more metering and rate limiting services 814, one or more outbound toxicity and bias detection services 824, one or more data demasking services 826, a feedback framework 828, an audit trail service 830, generations 832, prompt templates 806, and a one or more flow and/or vector search services 834.

For the purpose of illustration, the trust model 800 is shown with arrows illustrating a simple flow that may employ various components. In practice, however, the trust layer 630 may be used to perform various types of complex operations that may operate outside the linear flow illustrated in the trust model 800. However, the simple flow shown in FIG. 8 may be used to understand the operation and interaction of the various elements included in the trust layer 630.

For the purpose of illustration, consider a request generated by one or more applications and workflows 644. For instance, the request may be natural language text input provided by a user, an operation instruction triggered by an action performed in the context of an application, or some other type of request. Such a request may be sent to the orchestration and inference services 804.

According to various embodiments, the orchestration and inference services 804 may analyze the request to determine an intent, execute one or more actions, generate novel text, interact with the database system, receive and/or transmit one or more messages, and/or perform other types of operations. In service of performing these operations, the orchestration and inference services 804 may access one or more prompt templates 806, one or more actions stored in the action repository 628, and/or other preconfigured definitions or templates.

According to various embodiments, the orchestration and inference services 804 may transmit information to one or more artificial intelligence libraries 808, which may trigger the retrieval of information via the one or more retrieval augmented generation services 810. The one or more retrieval augmented generation services 810 may retrieve information from inside and/or outside of the computing services environment via the data interface 636 and/or the virtualization interface 638 through the flow and/or vector search interface 834. Retrieved information may be added to a prompt template or used to perform an action.

In some embodiments, prompts and other requests to artificial intelligence models may be processed via one or more toxicity detection and/or data masking services 812. Toxicity detection services, bias detection services, and/or other such evaluators may seek to determine whether a request is likely to generate text or other output deemed biased, offensive, or otherwise unacceptable or impermissible. Data masking may replace some information, such as personally identifying information, with blanks, unique identifiers, or other such values.

In some implementations, requests may be further processed via one or more metering and/or rate limiting services 814. Metering and/or rate limiting services 814 may help to ensure that requests to models do not exceed a designated rate. For instance, one or more requests may be queued to ensure that a request rate for a designated model, user, organization, or other context does not exceed a designated threshold.

In some implementations, requests to models may be sent via the model gateway 632. According to various embodiments, the model gateway 632 may be used to access one or more hosted models 818 hosted by the computing services environment 600, one or more tenant models 822 hosted by a customer organization, and/or one or more external models 820 hosted by a third-party service provider. Depending on the configuration, different models may reside inside of the trust layer, outside of the trust layer, and/or in an intermediate zone such as a shared trust environment.

In some embodiments, responses from models, such as prompt completions generated by a generative language model, may be evaluated for toxicity and bias by one or more toxicity and/or bias detection services at 824. Such evaluation may help to ensure that the system does not perform operations or return text that includes impermissible, objectionable, offensive content.

According to various embodiments, data demasking may be performed at 826. For instance, personally identifying information in an input prompt to a generative language model may be replaced with randomly generated unique identifiers by one or more data masking services 812. Then, when the generative language model returns a prompt completion that includes one or more of the randomly generated unique identifiers, the identifiers may be replaced with the personally identifying information. In this way, the system may generate text and/or take other actions that include or reflect personally identifying information, while at the same time not exposing such information to services outside the trust model such as externally hosted generative language models.

In some embodiments, feedback regarding actions, text generated by large language models, and/or other such operations may be determined and stored via the feedback framework 828. Such information may be used to train models, guide subsequent actions, and/or otherwise refine the operations of an autonomous agent.

In some implementations, the audit trail service 830 may aggregate and store information used to provide a record of actions taken by the system in the course of executing operations associated with an autonomous agent. Such information may be stored in a database system accessible via the computing services environment 600.

In some embodiments, text and other output generated as part of the processing of requests from the requests and workflows 608 may be returned to the applications and workflows 608 as generations at 832. Generations 832 may include, but are not limited to: text to be presented in a chat interface, instructions regarding actions to be performed in the context of providing an application or workflow, or other such information.

In some implementations, generations may be extracted from novel text generated by a generative language model. For instance, a generative language model may be provided with a prompt that includes information such as: (1) one or more natural language instructions to be executed by the generative language model, (2) input data to be used by the generative language model as needed in the course of executing the one or more natural language instructions, (3) one or more parameters governing the execution of the one or more natural language instructions, (4) any other information. The input data may include text data, structured data, unstructured data, or any other type of data. The generative language model may then execute the one or more natural language instructions to generate novel text.

In some embodiments, the novel text may include natural language, such as natural language to include in a message to a user, a field in a database record, a computing services environment log, or the like. Alternatively, or additionally, the novel text may include data, such as numerical data to use in updating a database record, data indicating a selection of one or more computing resources and elements within the computing services environment. For example, computing resources and elements such as topics, actions, computing devices, clients, users, and more may be associated with corresponding unique identifiers. The generative language model may generate novel text that includes such unique identifiers. The unique identifiers may then be extracted from the novel text by the computing services environment and used to trigger and/or inform the performance of operations within the computing services environment.

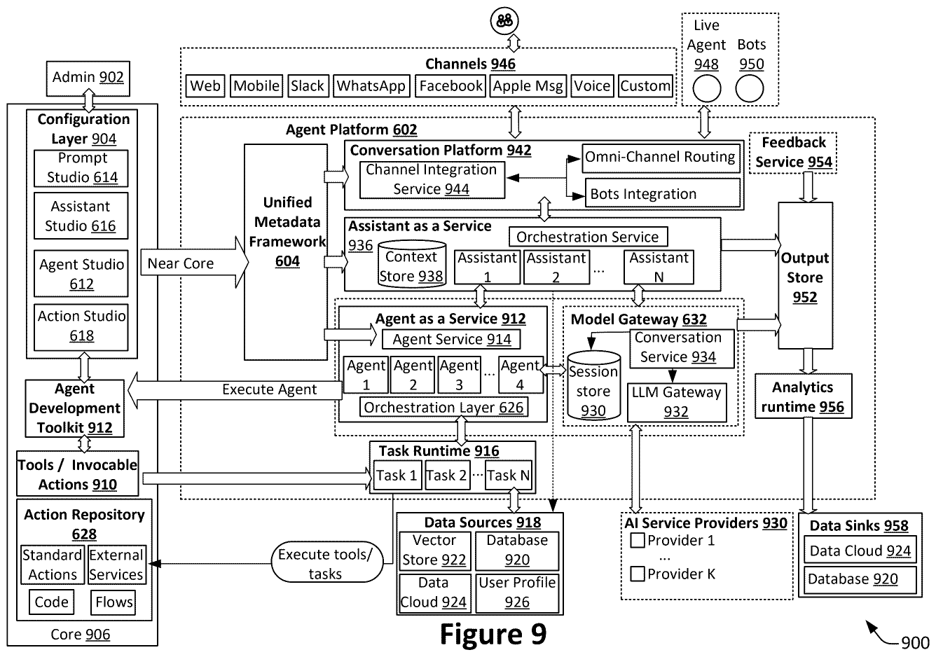

FIG. 9 illustrates an architecture diagram 900 of elements of the computing services environment 600, configured in accordance with one or more embodiments. The architecture diagram 900 is provided to illustrate additional details related to the operation of the computing services environment 600 with respect to the agent platform 602.

In the architecture diagram 900, an administrator 902 or other user interacts with an agent configuration layer 904 within the core 906 of the computing services environment. The configuration layer includes various elements, discussed in FIG. 6, for configuring agents. Collectively these tools provide access to an agent development toolkit 912 for defining and configuring tools and invocable actions 910 within the computing services environment. An agent may be composed of metadata references to such tools and invocable actions 910, as well as other metadata entries.

According to various embodiments, metadata entries may be specified within the unified metadata framework 604 within the agent platform 602. The metadata entries may be used to specify actions and operations associated with elements within the agent platform 602 used to provide the agents.

In some implementations, as a central element, the agent as a service platform 912 provides for the instantiation and execution of agents via the agent service 914. The orchestration layer 626 may be used to perform operations such as selecting agents, selecting planners, and determining plans. When an agent performs an action, the action may be implemented as a task executed by the task runtime 916.

In some embodiments, executing a task may involve retrieving data from one or more of the data sources 918. The data sources 918 may include a variety of data sources inside and/or outside of the computing services environment 600, including the database system 920, a vector store 922, a data cloud 924 providing access to, for instance, unstructured data, and user profiles 926.

In some embodiments, as another central element, the agent as a service platform 912 may coordinate with the model gateway 628 to communicate with generative language models and/or other artificial intelligence and/or machine learning models. The conversation service 934 may coordinate the generation of natural language text via the LLM gateway 932. The service platform 912 may communicate with AI service providers 930, which may be located inside or outside of the computing services environment 600.

According to various embodiments, as a particular kind of agent, conversational chat assistants may be accessed via the assistant as a service platform 936. Information pertaining to instances of conversational chat assistants may be stored in the context store 938. For instance, records of conversations as well as other supporting metadata may be used to save the state of a conversational chat assistant and then restore the state at a later point in time. A conversational chat assistant orchestration service 940 may coordinate operations of conversational chat assistants, including communication via the conversation platform 942. The conversation platform 942 may coordinate communication via various communication channels 946 via a channel integration service 944. Any of a variety of communication channels may be supported, including custom channels defined by customer organizations of the computing services environment 600. The conversation platform 942 may also support agent interactions with human agents 948 and/or computing programs 950 located outside of the agent platform 602.

According to various embodiments, information determined by the agents may be stored to an output store 952. Feedback regarding agent performance may be provided via a feedback service 954, and information analyzed via an analytics runtime 956 may be stored to one or more data sinks 958, such as the database system 920 and/or the data cloud 924.

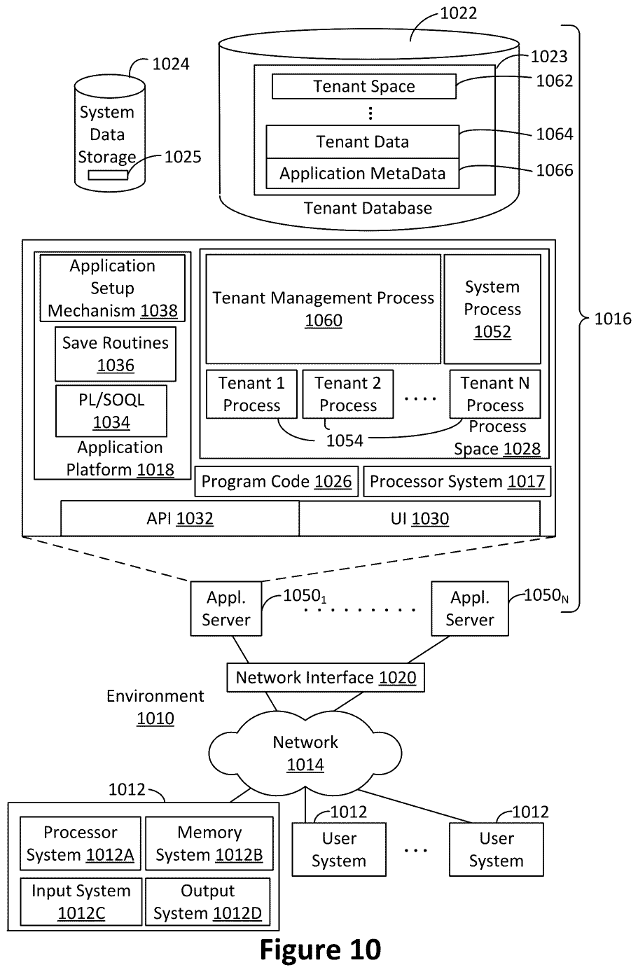

FIG. 10 shows a block diagram of an example of an environment 1010 that includes an on-demand database service configured in accordance with some implementations. Environment 1010 may include user systems 1012, network 1014, database system 1016, processor system 1017, application platform 1018, network interface 1020, tenant data storage 1022, tenant data 1023, system data storage 1024, system data 1025, program code 1026, process space 1028, User Interface (UI) 1030, Application Program Interface (API) 1032, PL/SOQL 1034, save routines 1036, application setup mechanism 1038, application servers 1050-1 through 1050-N, system process space 1052, tenant process spaces 1054, tenant management process space 1060, tenant storage space 1062, user storage 1064, and application metadata 1066. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

According to various embodiments, the environment 1010 may provide access to an agent platform. As shown in FIG. 10, the environment 1010 may also include other elements beyond the agent platform, such as computing components used to provide other types of computing services. Agents accessible via the agent platform may interoperate with such computing services. For instance, agents may trigger, configure, be triggered by, and/or accessed via such computing services.

An on-demand database service, implemented using system 1016, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 1018 may be a framework that allows the creation, management, and execution of applications in system 1016. Such applications may be developed by the database service provider or by users or third-party application developers accessing the service. Application platform 1018 includes an application setup mechanism 1038 that supports application developers'creation and management of applications, which may be saved as metadata into tenant data storage 1022 by save routines 1036 for execution by subscribers as one or more tenant process spaces 1054 managed by tenant management process 1060 for example. Invocations to such applications may be coded using PL/SOQL 1034 that provides a programming language style interface extension to API 1032. A detailed description of some PL/SOQL language implementations is discussed in commonly assigned U.S. Pat. No. 10,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 1066 for a subscriber making such an invocation. Such system processes may also manage execution of application metadata 1066 as an application in a virtual machine.

In some implementations, each application server 1050 may handle requests for any user associated with any organization. A load balancing function (e.g., an F5 Big-IP load balancer) may distribute requests to the application servers 1050 based on an algorithm such as least-connections, round robin, observed response time, etc. Each application server 1050 may be configured to communicate with tenant data storage 1022 and the tenant data 1023 therein, and system data storage 1024 and the system data 1025 therein to serve requests of user systems 1012. The tenant data 1023 may be divided into individual tenant storage spaces 1062, which can be either a physical arrangement and/or a logical arrangement of data. Within each tenant storage space 1062, user storage 1064 and application metadata 1066 may be similarly allocated for each user. For example, a copy of a user's most recently used (MRU) items might be stored to user storage 1064. Similarly, a copy of MRU items for an entire tenant organization may be stored to tenant storage space 1062. A UI 1030 provides a user interface and an API 1032 provides an application programming interface to system 1016 resident processes to users and/or developers at user systems 1012.

System 1016 may implement a web-based generative language model system. For example, in some implementations, system 1016 may include application servers configured to implement and execute generative language model software applications. The application servers may be configured to provide related data, code, forms, web pages and other information to and from user systems 1012. Additionally, the application servers may be configured to store information to, and retrieve information from a database system. Such information may include related data, objects, and/or Webpage content. With a multi-tenant system, data for multiple tenants may be stored in the same physical database object in tenant data storage 1022, however, tenant data may be arranged in the storage medium(s) of tenant data storage 1022 so that data of one tenant is kept logically separate from that of other tenants. In such a scheme, one tenant may not access another tenant's data, unless such data is expressly shared.

Several elements in the system shown in FIG. 10 include conventional, well-known elements that are explained only briefly here. For example, user system 1012 may include processor system 1012A, memory system 1012B, input system 1012C, and output system 1012D. A user system 1012 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 1012 to access, process and view information, pages and applications available from system 1016 over network 1014. Network 1014 may be any network or combination of networks of devices that communicate with one another, such as any one or any combination of a LAN (local area network), WAN (wide area network), wireless network, or other appropriate configuration.

The users of user systems 1012 may differ in their respective capacities, and the capacity of a particular user system 1012 to access information may be determined at least in part by “permissions” of the particular user system 1012. As discussed herein, permissions generally govern access to computing resources such as data objects, components, and other entities of a computing system, such as a generative language model platform, a social networking system, and/or a CRM database system. “Permission sets” generally refer to groups of permissions that may be assigned to users of such a computing environment. For instance, the assignments of users and permission sets may be stored in one or more databases of System 1016. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 1016 may provide on-demand database service to user systems 1012 using an MTS arrangement. By way of example, one tenant organization may be a company that employs a sales force where each salesperson uses system 1016 to manage their sales process. Thus, a user in such an organization may maintain contact data, leads data, customer follow-up data, performance data, goals and progress data, etc., all applicable to that user's personal sales process (e.g., in tenant data storage 1022). In this arrangement, a user may manage his or her sales efforts and cycles from a variety of devices, since relevant data and applications to interact with (e.g., access, view, modify, report, transmit, calculate, etc.) such data may be maintained and accessed by any user system 1012 having network access.

When implemented in an MTS arrangement, system 1016 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 1016 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 1016 may also maintain system-level data usable by multiple tenants or other data. Such system-level data may include industry reports, news, postings, and the like that are sharable between tenant organizations.

In some implementations, user systems 1012 may be client systems communicating with application servers 1050 to request and update system-level and tenant-level data from system 1016. By way of example, user systems 1012 may send one or more queries requesting data of a database maintained in tenant data storage 1022 and/or system data storage 1024. An application server 1050 of system 1016 may automatically generate one or more SQL statements (e.g., one or more SQL queries) that are designed to access the requested data. System data storage 1024 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 10,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

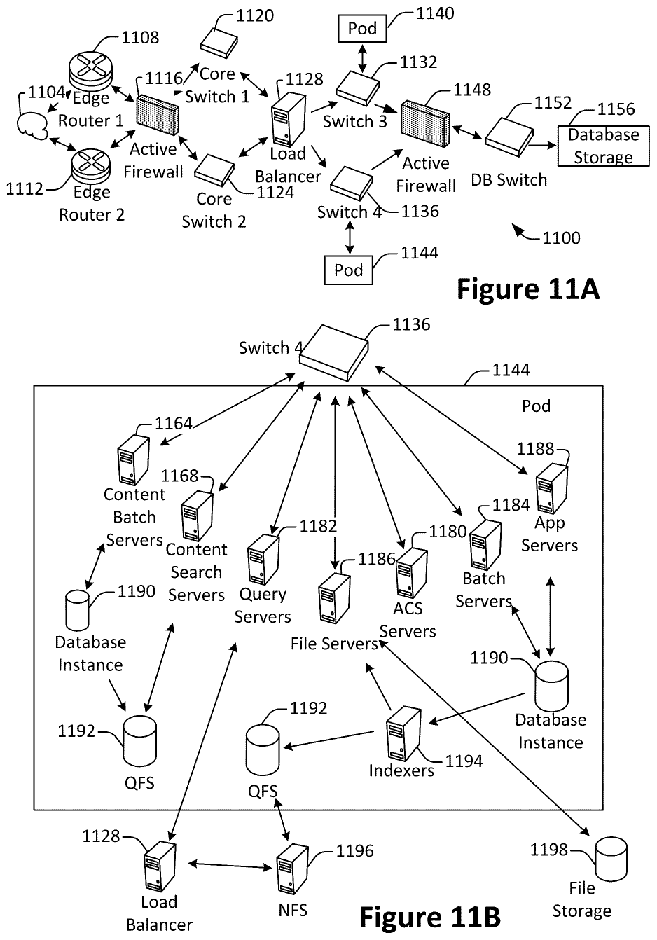

FIG. 11A shows a system diagram of an example of architectural components of an on-demand database service environment 1100, configured in accordance with some implementations. A client machine located in the cloud 1104 may communicate with the on-demand database service environment via one or more edge routers 1108 and 1112. A client machine may include any of the examples of user systems 1012 described above. The edge routers 1108 and 1112 may communicate with one or more core switches 1120 and 1124 via firewall 1116. The core switches may communicate with a load balancer 1128, which may distribute server load over different pods, such as the pods 1140 and 1144 by communication via pod switches 1132 and 1136. The pods 1140 and 1144, which may each include one or more servers and/or other computing resources, may perform data processing and other operations used to provide on-demand services. Components of the environment may communicate with a database storage 1156 via a database firewall 1148 and a database switch 1152.

Accessing an on-demand database service environment may involve communications transmitted among a variety of different components. The environment 1100 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 11A and 11B.

The cloud 1104 refers to any suitable data network or combination of data networks, which may include the Internet. Client machines located in the cloud 1104 may communicate with the on-demand database service environment 1100 to access services provided by the on-demand database service environment 1100. By way of example, client machines may access the on-demand database service environment 1100 to retrieve, store, edit, and/or process generative language model information.

In some implementations, the edge routers 1108 and 1112 route packets between the cloud 1104 and other components of the on-demand database service environment 1100. The edge routers 1108 and 1112 may employ the Border Gateway Protocol (BGP). The edge routers 1108 and 1112 may maintain a table of IP networks or ‘prefixes’, which designate network reachability among autonomous systems on the internet.

In one or more implementations, the firewall 1116 may protect the inner components of the environment 1100 from internet traffic. The firewall 1116 may block, permit, or deny access to the inner components of the on-demand database service environment 1100 based upon a set of rules and/or other criteria. The firewall 1116 may act as one or more of a packet filter, an application gateway, a stateful filter, a proxy server, or any other type of firewall.

In some implementations, the core switches 1120 and 1124 may be high-capacity switches that transfer packets within the environment 1100. The core switches 1120 and 1124 may be configured as network bridges that quickly route data between different components within the on-demand database service environment. The use of two or more core switches 1120 and 1124 may provide redundancy and/or reduced latency.

In some implementations, communication between the pods 1140 and 1144 may be conducted via the pod switches 1132 and 1136. The pod switches 1132 and 1136 may facilitate communication between the pods 1140 and 1144 and client machines, for example via core switches 1120 and 1124. Also or alternatively, the pod switches 1132 and 1136 may facilitate communication between the pods 1140 and 1144 and the database storage 1156. The load balancer 1128 may distribute workload between the pods, which may assist in improving the use of resources, increasing throughput, reducing response times, and/or reducing overhead. The load balancer 1128 may include multilayer switches to analyze and forward traffic.

In some implementations, access to the database storage 1156 may be guarded by a database firewall 1148, which may act as a computer application firewall operating at the database application layer of a protocol stack. The database firewall 1148 may protect the database storage 1156 from application attacks such as structure query language (SQL) injection, database rootkits, and unauthorized information disclosure. The database firewall 1148 may include a host using one or more forms of reverse proxy services to proxy traffic before passing it to a gateway router and/or may inspect the contents of database traffic and block certain content or database requests. The database firewall 1148 may work on the SQL application level atop the TCP/IP stack, managing applications' connection to the database or SQL management interfaces as well as intercepting and enforcing packets traveling to or from a database network or application interface.

In some implementations, the database storage 1156 may be an on-demand database system shared by many different organizations. The on-demand database service may employ a single-tenant approach, a multi-tenant approach, a virtualized approach, or any other type of database approach. Communication with the database storage 1156 may be conducted via the database switch 1152. The database storage 1156 may include various software components for handling database queries. Accordingly, the database switch 1152 may direct database queries transmitted by other components of the environment (e.g., the pods 1140 and 1144) to the correct components within the database storage 1156.

FIG. 11B shows a system diagram further illustrating an example of architectural components of an on-demand database service environment, in accordance with some implementations. The pod 1144 may be used to render services to user(s) of the on-demand database service environment 1100. The pod 1144 may include one or more content batch servers 1164, content search servers 1168, query servers 1182, file servers 1186, access control system (ACS) servers 1180, batch servers 1184, and app servers 1188. Also, the pod 1144 may include database instances 1190, quick file systems (QFS) 1192, and indexers 1194. Some or all communication between the servers in the pod 1144 may be transmitted via the switch 1136.

In some implementations, the app servers 1188 may include a framework dedicated to the execution of procedures (e.g., programs, routines, scripts) for supporting the construction of applications provided by the on-demand database service environment 1100 via the pod 1144. One or more instances of the app server 1188 may be configured to execute all or a portion of the operations of the services described herein.

In some implementations, as discussed above, the pod 1144 may include one or more database instances 1190. A database instance 1190 may be configured as an MTS in which different organizations share access to the same database, using the techniques described above. Database information may be transmitted to the indexer 1194, which may provide an index of information available in the database 1190 to file servers 1186. The QFS 1192 or other suitable filesystem may serve as a rapid-access file system for storing and accessing information available within the pod 1144. The QFS 1192 may support volume management capabilities, allowing many disks to be grouped together into a file system. The QFS 1192 may communicate with the database instances 1190, content search servers 1168 and/or indexers 1194 to identify, retrieve, move, and/or update data stored in the network file systems (NFS) 1196 and/or other storage systems.

In some implementations, one or more query servers 1182 may communicate with the NFS 1196 to retrieve and/or update information stored outside of the pod 1144. The NFS 1196 may allow servers located in the pod 1144 to access information over a network in a manner similar to how local storage is accessed. Queries from the query servers 1122 may be transmitted to the NFS 1196 via the load balancer 1128, which may distribute resource requests over various resources available in the on-demand database service environment 1100. The NFS 1196 may also communicate with the QFS 1192 to update the information stored on the NFS 1196 and/or to provide information to the QFS 1192 for use by servers located within the pod 1144.

In some implementations, the content batch servers 1164 may handle requests internal to the pod 1144. These requests may be long-running and/or not tied to a particular customer, such as requests related to log mining, cleanup work, and maintenance tasks. The content search servers 1168 may provide query and indexer functions such as functions allowing users to search through content stored in the on-demand database service environment 1100. The file servers 1186 may manage requests for information stored in the file storage 1198, which may store information such as documents, images, basic large objects (BLOBs), etc. The query servers 1182 may be used to retrieve information from one or more file systems. For example, the query system 1182 may receive requests for information from the app servers 1188 and then transmit information queries to the NFS 1196 located outside the pod 1144. The ACS servers 1180 may control access to data, hardware resources, or software resources called upon to render services provided by the pod 1144. The batch servers 1184 may process batch jobs, which are used to run tasks at specified times. Thus, the batch servers 1184 may transmit instructions to other servers, such as the app servers 1188, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

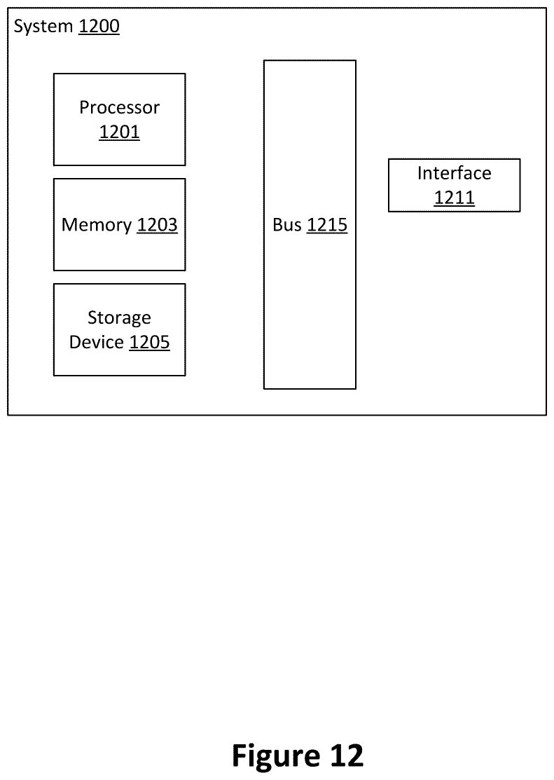

FIG. 12 illustrates one example of a computing device. According to various embodiments, a system 1200 suitable for implementing embodiments described herein includes a processor 1201, a memory module 1203, a storage device 1205, an interface 1211, and a bus 1215 (e.g., a PCI bus or other interconnection fabric.) System 1200 may operate as variety of devices such as an application server, a database server, or any other device or service described herein. Although a particular configuration is described, a variety of alternative configurations are possible. The processor 1201 may perform operations such as those described herein. Instructions for performing such operations may be embodied in the memory 1203, on one or more non-transitory computer readable media, or on some other storage device. Various specially configured devices can also be used in place of or in addition to the processor 1201. The interface 1211 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

### Conclusion

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of JSON. However, the techniques of the present invention apply to a wide variety of formatting configurations. Particular embodiments may be implemented without some or all of the specific details described herein. In other instances, well known process operations have not been described in detail in order not to unnecessarily obscure the present invention. Accordingly, the breadth and scope of the present application should not be limited by any of the implementations described herein, but should be defined only in accordance with the claims and their equivalents.

1. A computing services environment, comprising:
a plurality of application servers providing computing services to a plurality of entities, the computing services including access to a database system hosted within the computing services environment;
an agent studio configured to create a personal autonomous agent definition based on configuration information, the personal autonomous agent definition being specific to a user account of a plurality of user accounts within the computing services environment, the personal autonomous agent definition referencing a plurality of action definitions within a unified metadata framework defining a plurality of actions capable of being performed within the computing services environment;
an agent service configured to instantiate an autonomous agent instance based on the personal autonomous agent definition, the autonomous agent instance being associated with a runtime context specific to the user account; and
an orchestration layer configured to determine an orchestration plan based on novel planning text generated by a generative language model, the novel planning text being generated based on the user account and the personal autonomous agent definition, the orchestration plan including a subset of the plurality of actions, the computing services environment being configured to execute the subset of the plurality of actions, wherein executing a designated action of the subset of the plurality of actions includes updating a database record in the database system associated with the user account.

2. The computing services environment recited in claim 1, wherein a portion of the configuration information is received via an agent configuration graphical user interface generated via the agent studio.

3. The computing services environment recited in claim 1, wherein a portion of the configuration information is determined based on a sequence of actions performed upon request by the user account via an application graphical user interface generated via an application server of the plurality of application servers.

4. The computing services environment recited in claim 3, wherein the agent studio is configured to record the sequence of actions upon receiving a recording request from the user account.

5. The computing services environment recited in claim 3, wherein the agent studio is configured to autonomously determine the sequence of actions by searching for patterns within interactions between the user account and the computing services environment.

6. The computing services environment recited in claim 1, wherein an action of the plurality of actions corresponds to an instruction to generate novel text via the generative language model, and wherein updating the database record in the database system includes storing the novel text in associate with the database record.

7. The computing services environment recited in claim 1, wherein a first action of the plurality of actions corresponds to retrieving one or more database records from the database system based on a database query determined by the generative language model upon request by the agent studio based on the configuration information.

8. The computing services environment recited in claim 7, wherein a second action of the plurality of actions corresponds to determining record-specific textual information corresponding to the one or more database records via the generative language model.

9. The computing services environment recited in claim 8, wherein a third action of the plurality of actions corresponds to updating the one or more database records to include the record-specific textual information.

10. The computing services environment recited in claim 8, wherein a third action of the plurality of actions corresponds to transmitting one or more messages corresponding to the one or more database records and including the record-specific textual information.

11. The computing services environment recited in claim 1, wherein the agent studio is configured to publish an account-agnostic template based on the personal autonomous agent definition, the account-agnostic template being made available to other user accounts within the computing services environment.

12. A method implemented in a computing services environment including a hardware processor and a database system, the method comprising:
providing computing services to a plurality of entities via a plurality of application servers, the computing services including access to the database system;
creating a personal autonomous agent definition via an agent studio based on configuration information, the personal autonomous agent definition being specific to a user account of a plurality of user accounts within the computing services environment, the personal autonomous agent definition referencing a plurality of action definitions within a unified metadata framework defining a plurality of actions capable of being performed within the computing services environment;
instantiating an autonomous agent instance via an agent service based on the personal autonomous agent definition, the autonomous agent instance being associated with a runtime context specific to the user account; and
determining an orchestration plan via an orchestration layer based on novel planning text generated by a generative language model, the novel planning text being generated based on the user account and the personal autonomous agent definition, the orchestration plan including a subset of the plurality of actions, the computing services environment being configured to execute the subset of the plurality of actions, wherein executing a designated action of the subset of the plurality of actions includes updating a database record in the database system associated with the user account.

13. The method recited in claim 12, wherein a portion of the configuration information is received via an agent configuration graphical user interface generated via the agent studio.

14. The method recited in claim 12, wherein a portion of the configuration information is determined based on a sequence of actions performed upon request by the user account via an application graphical user interface generated via an application server of the plurality of application servers.

15. The method recited in claim 14, wherein the agent studio is configured to record the sequence of actions upon receiving a recording request from the user account.

16. The method recited in claim 14, wherein the agent studio is configured to autonomously determine the sequence of actions by searching for patterns within interactions between the user account and the computing services environment.

17. The method recited in claim 12, wherein an action of the plurality of actions corresponds to an instruction to generate novel text via the generative language model, and wherein updating the database record in the database system includes storing the novel text in association with the database record.

18. One or more non-transitory computer readable media having instructions stored thereon for performing a method implemented in a computing services environment including a hardware processor and a database system, the method comprising:
providing computing services to a plurality of entities via a plurality of application servers, the computing services including access to the database system;
creating a personal autonomous agent definition via an agent studio based on configuration information, the personal autonomous agent definition being specific to a user account of a plurality of user accounts within the computing services environment, the personal autonomous agent definition referencing a plurality of action definitions within a unified metadata framework defining a plurality of actions capable of being performed within the computing services environment;
instantiating an autonomous agent instance via an agent service based on the personal autonomous agent definition, the autonomous agent instance being associated with a runtime context specific to the user account; and
determining an orchestration plan via an orchestration layer based on novel planning text generated by a generative language model, the novel planning text being generated based on the user account and the personal autonomous agent definition, the orchestration plan including a subset of the plurality of actions, the computing services environment being configured to execute the subset of the plurality of actions, wherein executing a designated action of the subset of the plurality of actions includes updating a database record in the database system associated with the user account.

19. The one or more non-transitory computer readable media recited in claim 18, wherein a portion of the configuration information is received via an agent configuration graphical user interface generated via the agent studio.

20. The one or more non-transitory computer readable media recited in claim 18, wherein a portion of the configuration information is determined based on a sequence of actions performed upon request by the user account via an application graphical user interface generated via an application server of the plurality of application servers.
